(19) United States
(12) Patent Application Publication
(10) Pub. No.: US 2010/0302371 A1
(43) Pub. Date: Dec. 2, 2010

(54) Vehicle tailgating detection system

(76) Inventor: Mark Abrams, Thousand Oaks, CA (US)

Correspondence Address: Larry F. Gitlin, Esq.;RAPKIN GITLIN & BEAUMONT, Ste. 1620, 21650 Oxnard Street, Woodland Hills, CA, 91367, US

(21) Appl. No.: 12/454,859

(22) Filed: May 27, 2009

(51) Int. Cl. H04N 7/18

(52) U.S. Cl. 348/149; 348/E07.085

(57) ABSTRACT

Vehicle tailgating detection system comprising an unmarked police vehicle having a back end, a camera, still or video, installed on the police vehicle facing rearwards for acquiring and recording visual identification information about the tailgating vehicle during the tailgating incident, and a proximity sensor installed on the police vehicle to determine and transmit information about the distance between the unmarked police vehicle and the tailgating vehicle. Also included is a data processing computer for recording and processing identifying information about the tailgating vehicle, information about the distance between the vehicles and the speed of the vehicles, and information about the location, date and time of the tailgating incident. A global positioning navigation device for acquiring and recording information about the location coordinates of the vehicles during the tailgating incident and means to print a report with details about the tailgating incident from which a moving violation citation may be issued are also provided.

### BACKGROUND OF THE INVENTION

1. Field of the Invention

This invention relates generally to systems for improving the enforcement of traffic laws and more particularly to the enforcement of laws pertaining to tailgating violations.

2. Description of the Prior Art

A moving vehicle tailgating another moving vehicle ahead of it is inherently dangerous to the occupants of both vehicles as well as vehicles nearby in the event of an accident. A tailgating vehicle, or vehicle following another vehicle too closely, simply does not have sufficient time nor is the reaction time of even the most aware and capable driver sufficient enough to prevent an accident should the two vehicles collide after the lead vehicle is caused to stop short or suddenly decelerate. The obvious immediate consequences of an accident resulting from a tailgating incident is the physical injury to the vehicle's occupants and physical damage to the vehicles involved. Of lesser importance, but still an issue, is the traffic congestion and increased insurance rates that result from accidents caused by tailgating incidents.

Identifying a tailgater is not always easy for a police officer in a moving vehicle or even a police officer parked along the roadside observing cars as they drive by. Typically, a vehicle is deemed to be tailgating another vehicle when the tailgating vehicle is traveling behind the other at or near a constant speed and distance to be at risk of a collision if the vehicle in front suddenly stops or decelerates. The key to determining whether or not a vehicle is actually tailgating another is the amount of time and distance the tailgating incident persists. Momentary tailgating, such as when the vehicle in the rear moves up close to the vehicle in front but then immediately backs off upon realizing the unsafe condition, may not necessarily qualify as a technical act of tailgating. The violation is more apparent when the tailgating vehicle maintains speed and distance over sufficient time, creating an especially unsafe condition. Thus, to establish the violation with the degree of certainty that would legally support and justify a citation, the police officer must “shadow” or follow the two vehicles involved for a sufficient distance over a sufficient period of time. Just as importantly, the police vehicle would need to move into a position with a particularly favorable vantage point to enable the officer to observe the distance between the two vehicles. Again, this can be difficult to achieve, especially if the police cruiser is marked with law enforcement identifiers.

Employing the improved system of the present invention, the vehicle traveling in front of the tailgating vehicle is an unmarked police cruiser with the means to determine the speed of the tailgating vehicle, the distance between the tailgating vehicle and the unmarked vehicle, and the time and location of the tailgating incident. This system also includes the means to identify the tailgating vehicle by recording the license plate number and/or in information about the make, model and year of the vehicle. This information is then transmitted to and processed through a computer situated inside the police vehicle and a printed detailed report of the incident is provided.

The prior art teaches several systems employed for monitoring unsafe conditions involving moving vehicles on a highway, including some involving incidents of tailgating. However, none of the prior art systems includes the combination of elements and achieves the specific objective associated with the improved system of the present invention. Examples include U.S. Pre-grant Publication No. 2008/0062009 (Marton), which teaches a system to detect and cite tailgating violations. The system comprises a tailgating detector adapted to detect a tailgating vehicle, a recorder adapted to record identification information specific to the tailgating vehicle, an identification computer in communication with a vehicle and registrant identification information database, a citation preparation computer adapted to prepare a tailgating citation, and a communication means for communicating the tailgating citation to the tailgating violator; U.S. Pre-grant Publication No. 2008/0061953 (Bhogal, et al.) teaches a method, system, and computer program product for detecting a tailgate event between two moving vehicles. The system includes a range sensor that determines a distance between the two vehicles. The system also includes a processor that calculates a safe distance range between the two vehicles based upon speed, weight, and/or safe braking range values of one or both of the two vehicles; and compares the distance and the safe distance range. The system also includes a recording device on the affected vehicle. Based upon the comparison, the recording device is activated if the distance is less than the safe distance range indicating an unacceptable distance range value; U.S. Pat. No. 7,057,501 (Davis) teaches a tailgate warning system, for use in a target vehicle, for determining unsafe following and followed distances, having a front rangefinder, a rear rangefinder, a vehicle speed sensor, incident memory, hazard lights, and a control unit. When an unsafe following distance is determined by the control unit using the front rangefinder and speed sensor, a dashboard audible visual alert is activated. When an unsafe followed distance is determined by the control unit using the rear rangefinder and speed sensor, the dashboard audible visual alert and the hazard lights are activated. Incidents of tailgating are recorded in the incident memory; and U.S. Pat. No. 6,534,884 (Marcus, et al.), which teaches a vehicle proximity sensing system for sensing vehicle activity rearward of a driver of a vehicle comprising a proximity sensor, an information display and a control. The proximity sensor senses vehicle activity rearward of the driver of a subject vehicle to detect an approach of a rearwardly approaching vehicle. The information display alerts the driver of the subject vehicle that the rearwardly approaching vehicle is within a threshold distance. The control is operable to generate an alert on the information display in response to the proximity sensor.

### SUMMARY OF THE INVENTION

The vehicle tailgating detection system of the present invention comprises an unmarked police vehicle having a back end and a front end, a camera, still or video, installed on or within the police vehicle facing rearwards for acquiring and recording visual identification information about the tailgating vehicle during the tailgating incident, and a proximity sensor installed on or within the police vehicle to determine and transmit information about the distance between the unmarked police vehicle and the tailgating vehicle. Also included as part of the system is a data processing computer for recording and processing identifying information about the tailgating vehicle, information about the distance between the vehicles and the speed of the vehicles, and information about the location, date and time of the tailgating incident. A global positioning navigation device is also provided to acquire and record information about the location coordinates of the vehicles during the tailgating incident. Also a part of the system are the means to print a report with details about the tailgating incident from which a moving violation citation may be issued.

Accordingly, an object of the present invention is to provide an improved system for detecting and documenting vehicle tailgating violations.

Still another object of the present invention is to provide an improved system for detecting vehicle tailgating violations which utilizes an unmarked police vehicle to improve the system's effectiveness, reliability and overall accuracy.

Still another object of the present invention is to provide an improved system for detecting vehicle tailgating violations which utilizes global positioning technology to establish the exact location of the tailgating incident.

Still another object of the present invention is to provide an improved system for detecting vehicle tailgating violations which provides the means to determine and record a wide variety of important data about the tailgating incident from which a moving violation citation may be issued.

Still another object of the present invention is to provide an improved system for detecting vehicle tailgating violations which is easy to install and operate.

Still another object of the present invention is to provide an improved system for detecting vehicle tailgating violations which is easy and cost effective to manufacture and maintain.

Still another object of the present invention is to provide an improved system for detecting vehicle tailgating violations which is highly mobile.

The features of this invention, which are believed to be novel, are set forth with particularity in the appended claims. The present invention, both as its organization and manner of operation, together with further objects and advantages thereof, may be best understood by reference to the following description, taken in conjunction with the accompanying drawings.

### BRIEF DESCRIPTION OF THE DRAWINGS

FIG. 1 is a perspective view of two vehicles with one tailgating the other in accordance with the present invention.

FIG. 2 is a perspective view of the interior of the unmarked police vehicle showing the view of the dash from the front seats of the vehicle and various elements of the system in accordance with the present invention.

FIG. 3 is a front elevation of the front end of the tailgating vehicle in accordance with the present invention.

FIG. 4 is a rear elevation of the rear end of the unmarked police vehicle in accordance with the present invention.

FIG. 5 is a block diagram illustrating the steps performed in the operation of the system of the present invention.

### DETAILED DESCRIPTION OF THE PREFERRED EMBODIMENT

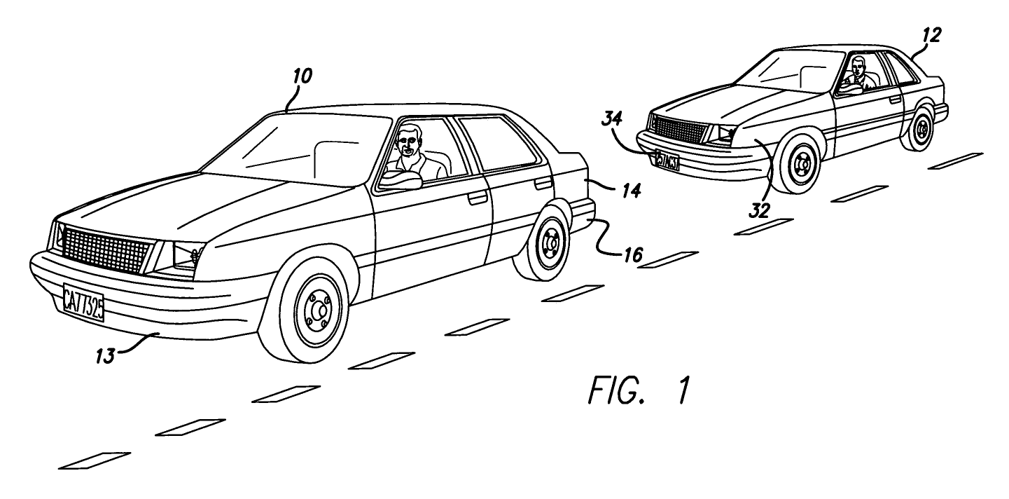

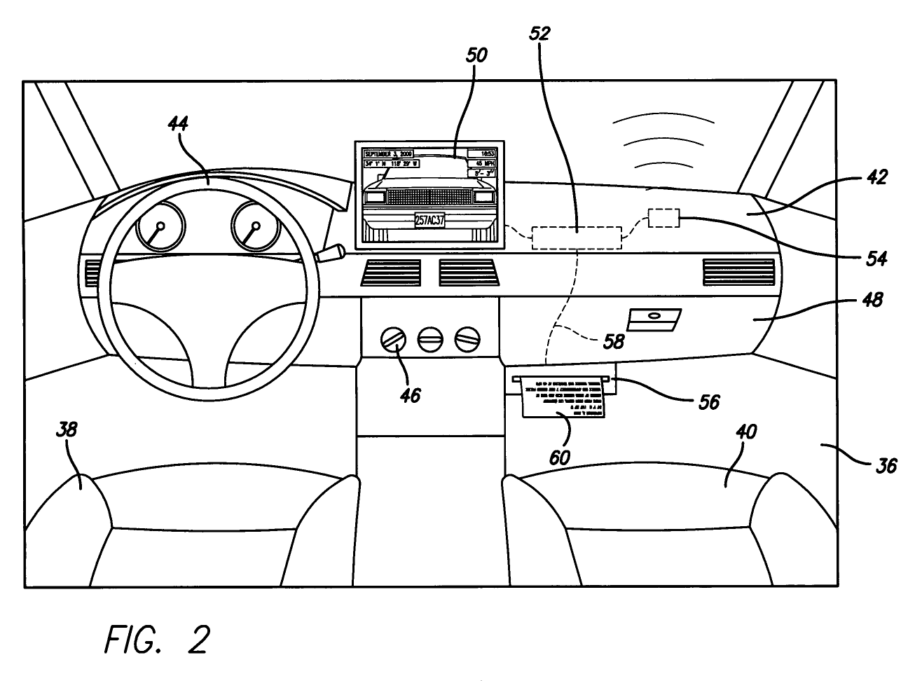

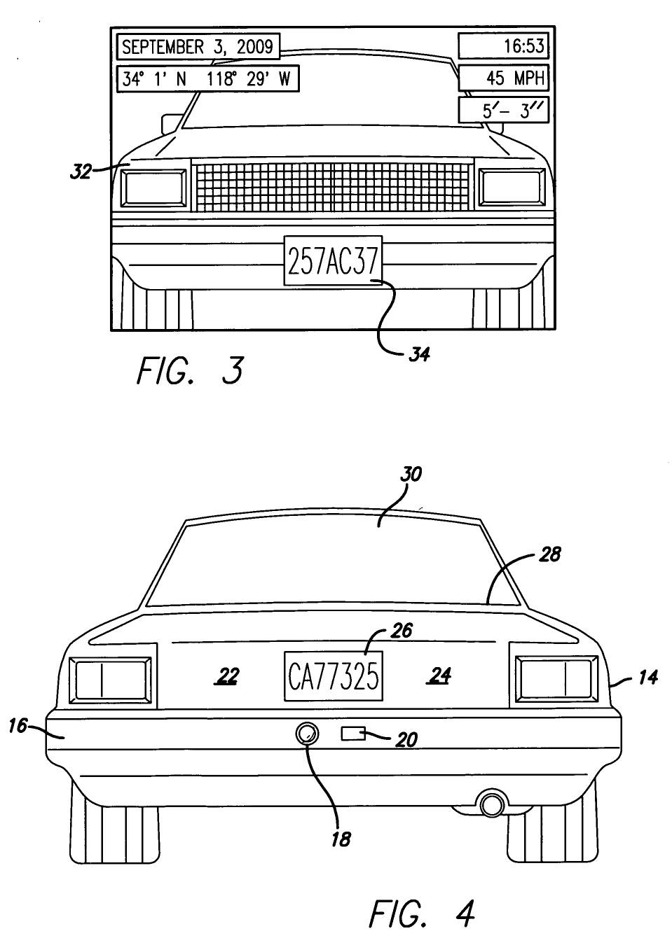

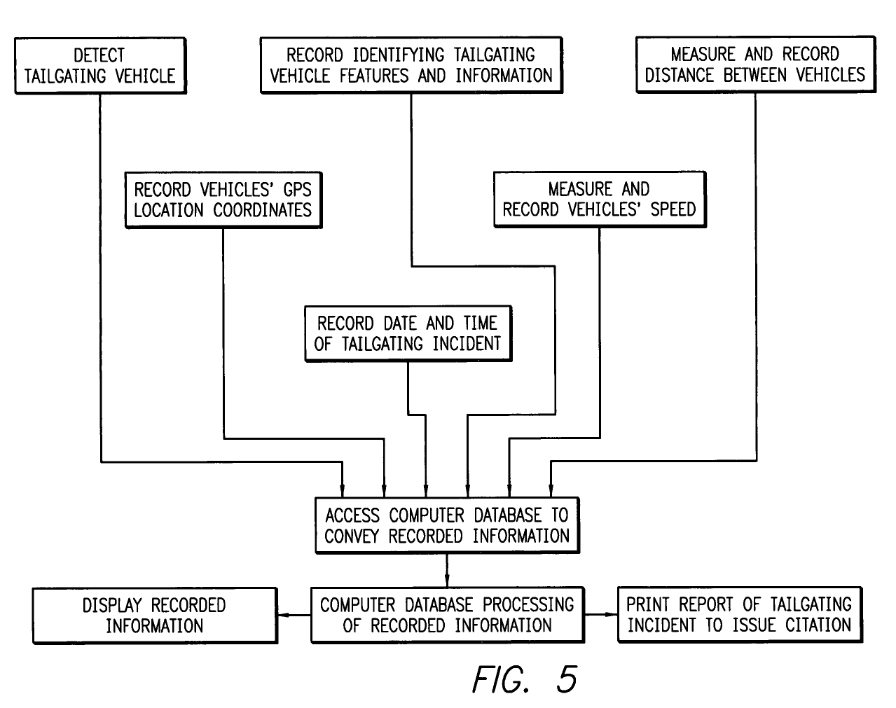

FIG. 1 illustrates tailgating vehicle 10 and vehicle 12 in accordance with the preferred embodiment of the present invention. Vehicles 10 and 12 are conventional in design and construction and may be of any make or model. Vehicle 10 is a police cruiser, unmarked out of necessity given the objective of the invention and the obvious need for anonymity. Vehicle 10 can be a sedan, coupe or convertible, or even a truck, and includes front end 13 and back end 14. Back end 14 comprises bumper 16 having camera 18 and proximity sensor 20 installed thereon. Camera 18, which can be either a still camera or a video camera, is installed in or on bumper 16 so that it faces rearwardly towards vehicle 12 following closely behind. Also installed on or in bumper 16 is proximity sensor 20, which comprises conventional means to detect and monitor the distance between vehicles 10 and 12. Camera 18 and proximity sensor 20 may also be installed elsewhere in or on vehicle 10, such as section 22 or 24 on either side of license plate 26 or shelf 28 just inside rear window 30. The important consideration no matter where these devices are installed is the requirement that they be placed in a location that would maximize their abilities to detect and monitor the distance between the vehicles and record accurate identification information about the tailgating vehicle.

Vehicle 12, the tailgating vehicle, can be a sedan, coupe or convertible, or any other kind of vehicle, and includes front end 32, typically (though not always in some states), displaying a license plate 34.

Inside vehicle 10, like most conventional vehicles, is passenger cab 36, which includes driver seat 38 and at least one passenger seat, such as seat 40. In front of seats 38 and 40 is dash 42, into which a wide variety of devices, gauges and controls are installed. Among these items are steering wheel 44, air conditioning and/or heating controls 46 and glove box 48. Also installed in or on dash 42 are components that are integral to the operation and proper functioning of the present invention, including video monitor 50, computer or CPU 52, GPS device 54 and printer 56. These components, along with camera 18 and proximity sensor 20, are connected either by hardwire 58 or by wireless technology. Information, visual or otherwise, received or detected by camera 18, proximity sensor 20, and GPS device 54 is transmitted either to CPU 52 for processing (e.g., information about the distance between the vehicles or location coordinates) or directly to video monitor 50 (identification information about vehicle 12 recorded by camera 18). CPU 52 may also be programmed to convert location coordinates established by GPS device 54 to common street and highway designations.

The time and date are recorded by conventional means inside the vehicle and processed through CPU 52, eventually being displayed on video monitor 50 along with a video recording or still photo of the tailgating vehicle. Printer 56, electronically communicates with CPU 52, receives data from CPU 52 and then documents the data by printing it on paper 60. Alternative means are also available for collecting, transferring and downloading data, including, among them, computer hard drives and flash drives (not shown) and conveying the information over the internet or with the use of an orbiting satellite system established for this purpose. The printed document or downloaded data can then be used to produce accurate documentation of the tailgating incident by the police enforcement agency and the eventual traffic citation issued to the violator, which may then be mailed or conveyed in some other manner to the violator at a later date.

This invention has been described in its presently preferred embodiment, and it is clear that it is susceptible to numerous modifications, modes and embodiments within the ability of those skilled in the art and without the exercise of this inventive faculty.

What is claimed is:

1. A vehicle tailgating detection system installed in an unmarked police vehicle, comprising
an unmarked police vehicle having a back end and a front end;
a tailgating vehicle having a front end with identification information;
a camera installed in or on said unmarked police vehicle facing rearwards for acquiring visual information about said tailgating vehicle following closely behind said unmarked police vehicle during a tailgating incident;
a proximity sensor installed in or on said unmarked police vehicle to determine and transmit information about the distance between said unmarked police vehicle and said tailgating vehicle;
a global positioning satellite device to determine the location coordinates of said vehicles at the time of said tailgating incident;
a data processing computer for recording and processing identification information about said tailgating vehicle, the speed of said vehicles, the distance between said vehi-cles, and information about the location, date and time of said tailgating incident; and,
means to record a report about said tailgating incident for issuing a moving violation citation.

2. The vehicle tailgating detection system of claim 1 having a video monitor inside said police vehicle with a picture or video recording of said tailgating vehicle.

3. The vehicle tailgating detection system of claim 2 wherein said video monitor displays the date of said tailgating incident.

4. The vehicle tailgating detection system of claim 2 wherein said video monitor displays the location coordinates of said tailgating incident.

5. The vehicle tailgating detection system of claim 4 wherein said data processing computer converts said location coordinates to street or highway designations.

6. The vehicle tailgating detection system of claim 1 wherein said police vehicle has a bumper on said back end.

7. The vehicle tailgating detection system of claim 6 wherein said camera is installed on said bumper of said police vehicle.

8. The vehicle tailgating detection system of claim 6 wherein said proximity sensor is installed on said bumper of said police vehicle.

9. The vehicle tailgating detection system of claim 1 wherein said means to record a report about said tailgating incident comprises printing data processed by said computer onto a document.

10. The vehicle tailgating detection system of claim 1 wherein said means to record a report about said tailgating incident comprises downloading data processed by said computer onto a computer hard drive.

11. The vehicle tailgating detection system of claim 1 wherein said means to record a report about said tailgating incident comprises downloading data processed by said computer onto a computer flash drive.
